(19) United States
(12) Patent Application Publication
(10) Pub. No.: US 2020/0272400 A1
(43) Pub. Date: Aug. 27, 2020

(54) DISPLAY DEVICE

(71) Applicant: HONDA MOTOR CO., LTD., Tokyo (JP)

(72) Inventor: Masahiro Yoshino, Wako-shi (JP)

(21) Appl. No.: 16/789,453

(22) Filed: Feb. 13, 2020

(30) Foreign Application Priority Data
Feb. 22, 2019 (JP) 2019-030413

(51) Int. Cl. G06F 3/14; G06F 3/0482; G01C 21/34; B60K 35/00

(52) U.S. Cl. CPC G06F 3/1431; G06F 3/0482; B60K 37/04; G01C 21/3476; B60K 35/00; G01C 21/3484

(57) ABSTRACT

A plurality of displays; a display controller configured to determine each content of information to be displayed by each of the plurality of displays and to display the determined each content of information on each of the plurality of displays; and a receptor configured to receive a selection operation of an occupant, and in a case where an operation of selecting one of a plurality of options in a first mode is received by the receptor in a state where list information including the plurality of options is displayed on a first display included in the plurality of displays, the display controller is configured to display relevant information related to the option selected in the first mode on a second display different from the first display among the plurality of displays.

### CROSS-REFERENCE TO RELATED APPLICATION

This application claims priority to and the benefit from Japanese Patent Application No. 2019-030413, filed on Feb. 22, 2019, the contents of which are hereby incorporated by reference into the present application.

### BACKGROUND OF THE INVENTION

### Field of the Invention

The present invention relates to a display device.

### Description of Related Art

As a display device mounted on a vehicle, a known display device includes two displays, one display being mounted on a side of a driver's seat and the other display being provided on a side of a seat next to the driver (for example, Japanese Patent No. 3807918, hereinafter, referred to as “Patent Document 1”). In the display device, for example, information for the driver, for example, map information is displayed on the display on the side of the driver's seat, and information for a fellow passenger, for example, text information is displayed on the display on the side of the seat next to the driver. Examples of the text information include information on, for example, tourist sites around a route, gas stations, golf courses, family restaurants, and convenience stores. Regarding information displayed on the two displays, map information is changed over to text information through one operation, or text information is changed over to map information.

In the display device disclosed in Patent Document 1, there is no mention about which procedure information is displayed using two displays. Different pieces of information are displayed on two displays, but independent display control is performed on each of the displays. For this reason, for example, in a case where text information displayed on the display on the side of the seat next to the driver is changed over to map information when map information is displayed on the display on the side of the driver's seat, map information is displayed on both the display on the side of the driver's seat and the display on the side of the seat next to the driver. Therefore, the two displays may not be sufficiently utilized.

### SUMMARY OF THE INVENTION

The present invention is contrived in view of such circumferences, and one object thereof is to provide a display device which is capable of displaying information by sufficiently utilizing a plurality of displays.

A display device according to the present invention adopts the following configurations.

(1) A display device according to an aspect of the present invention includes a display device, comprising: a plurality of displays; a display controller configured to determine each content of information to be displayed by each of the plurality of displays and to display the determined each content of information on each of the plurality of displays; and a receptor configured to receive a selection operation of an occupant, in a case where an operation of selecting one of a plurality of options in a first mode is received by the receptor in a state where list information including the plurality of options is displayed on a first display included in the plurality of displays, the display controller is configured to display relevant information related to the option selected in the first mode on a second display different from the first display among the plurality of displays.

(2) In the aspect of (1), the display controller is configured to display the relevant information on the first display in a case where the option selected in the first mode is selected in a second mode.

(3) In the aspect of (2), the display controller is configured to display on the second display information displayed before displaying the relevant information on the second display in a case where the option selected in the first mode is selected in the second mode.

(4) In the aspect of (2), the display controller is configured to display the list information on the second display in a case where the option selected in the first mode is selected in the second mode.

(5) In the aspect of (2), the display controller is configured to display the list information on the second display until a predetermined period of time elapses in a case where the option selected in the first mode is selected in the second mode, and to display information displayed on the second display before displaying the relevant information on the second display in a case where an operation for the plurality of options is not received by the receptor over the predetermined period of time in a state where the list information is displayed on the second display.

(6) In the aspect of any one of (1) to (5), the display controller is configured to exchange information displayed on the first display and information displayed on the second display with each other in a case where an exchange instruction operation is received by the receptor

(7) In the aspect of (4) or (5), the first display and the second display may be provided in a vehicle including a driver's seat and a seat next to the driver, and the first display may be disposed on a side closer to the driver's seat than the second display, the second display is disposed on a side closer to the seat next to the driver than the first display, and the display controller is configured to continuously display the relevant information on the first display in a case where the option selected in the first mode, among the options included in the list information displayed on the second display, is selected in the second mode.

(8) In the aspect of (7), the display in a case where the option selected in the first mode, among the options included in the list information displayed on the second display, is selected in the second mode, the display controller is configured to continuously display the list information on the second display or to display information displayed on the second display before displaying the list information on the second display

(9) In the aspect of any one of (1) to (8), the list information is related to a list of energy supply stations, and the display controller is configured to generate list information to be displayed on at least one of the first display and the second display on the basis of at least one of a traveling history and a traveling schedule of a vehicle on which the display device is mounted.

(10) In the aspect of (9), the display controller is configured to separately perform first display in a first display mode for information on energy supply stations in a vicinity of a traveling path included in the traveling history and second display in a second display mode for information on energy supply stations in a vicinity of a traveling path included in the traveling schedule

(11) In the aspect of (9) or (10), the display controller is configured to exclude information on an energy supply station which is in a vicinity of a traveling path included in a traveling history of the vehicle and of which a distance from the vehicle is equal to or greater than a predetermined distance from the list information.

According to (3) and (5), it is possible to improve operability.

According to (4), it is possible to easily redo options of list information.

According to (6), it is possible to easily share information.

According to (7), it is possible to improve operability and visibility of list information of a driver.

According to (8), it is possible to easily redo the selection of list information by an assistant.

According to (9) to (11), it is possible to display an energy supply station suitable for energy supply.

### BRIEF DESCRIPTION OF THE DRAWINGS

FIG. 1 is a block diagram showing a configuration of a display device of a first embodiment.

FIG. 2 is a diagram showing an example of a screen displayed on the display device of the first embodiment.

FIG. 3 is a flowchart showing an example of a flow of processing executed in the display device of the first embodiment.

FIG. 4A is a diagram showing an example of a change in a display mode of the display device of the first embodiment.

FIG. 4B is a diagram showing an example of a change in a display mode of the display device of the first embodiment.

FIG. 4C is a diagram showing an example of a change in a display mode of the display device of the first embodiment.

FIG. 5A is a diagram showing an example of a change in a display mode of the display device of the first embodiment.

FIG. 5B is a diagram showing an example of a change in a display mode of the display device of the first embodiment.

FIG. 5C is a diagram showing an example of a change in a display mode of the display device of the first embodiment.

FIG. 6 is a flowchart showing an example of a flow of processing executed in a display device of a second embodiment.

FIG. 7A is a diagram showing an example of a change in a display mode of the display device of the second embodiment.

FIG. 7B is a diagram showing an example of a change in a display mode of the display device of the second embodiment.

FIG. 7C is a diagram showing an example of a change in a display mode of the display device of the second embodiment.

FIG. 7D is a diagram showing an example of a change in a display mode of the display device of the second embodiment.

FIG. 8 is a diagram showing an example of a screen displayed on a display device of a third embodiment.

FIG. 9 is a flowchart showing an example of a flow of processing executed in the display device of the third embodiment.

FIG. 10A is a diagram showing an example of a change in a display mode of the display device of the third embodiment.

FIG. 10B is a diagram showing an example of a change in a display mode of the display device of the third embodiment.

FIG. 10C is a diagram showing an example of a change in a display mode of the display device of the third embodiment.

FIG. 11A is a diagram showing an example of a change in a display mode of the display device of the third embodiment.

FIG. 11B is a diagram showing an example of a change in a display mode of the display device of the third embodiment.

### DETAILED DESCRIPTION OF THE INVENTION

Hereinafter, an embodiment of a display device of the present invention will be described with reference to the accompanying drawings. The display device is a display device that displays contents on a plurality of displays provided in a vehicle. The vehicle is, for example, an electric car. The vehicle may be a vehicle other than an electric car or may be a so-called gasoline car or hybrid car.

### First Embodiment

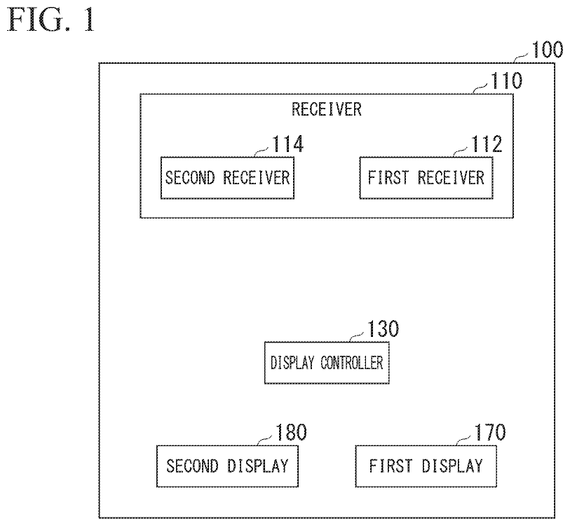

FIG. 1 is a block diagram showing a configuration of a display device 100 of a first embodiment. The display device 100 includes, for example, a receiver 110, a display controller 130, a first display 170, and a second display 180 different from the first display 170. The display device 100 is, for example, a vehicle display device mounted on a vehicle.

The first display 170 and the second display 180 are examples of “a plurality of displays”. The first display 170 and the second display 180 are, for example, two touch panel type display devices provided adjacent to each other. The first display 170 and the second display 180 may be different regions in one display device. A remote device such as a touch pad or a commander may be used instead of or in addition to the first display 170 and the second display 180 which are touch panel type display devices.

Some of the components of the receiver 110 and some or all of the components of the display controller 130 are realized by a hardware processor such as a central processing unit (CPU) executing programs (software). Some or all of these components may be realized by hardware (a circuit unit; circuitry is included) such as a large scale integration (LSI), an application specific integrated circuit (ASIC), a field-programmable gate array (FPGA), or a graphics processing unit (GPU), or may be realized by cooperation of software and hardware. The programs may be stored in a storage device (a storage device including a non-transitory storage medium) such as a hard disk drive (HDD) or a flash memory in advance, may be stored in a detachable storage medium (non-transitory storage medium) such as a DVD or a CD-ROM, or may be installed by a storage medium being mounted on a drive device.

The receiver 110 receives, for example, an operation of an occupant. The receiver 110 includes, for example, a first receiver 112 and a second receiver 114. The first receiver 112 receives an operation of an occupant using, for example, a graphical user interface (GUI) switch which is set in the first display 170. The second receiver 114 receives an operation of an occupant using, for example, a GUI switch which is set in the second display 180. The GUI switch is displayed in the form of, for example, a selection button or the like.

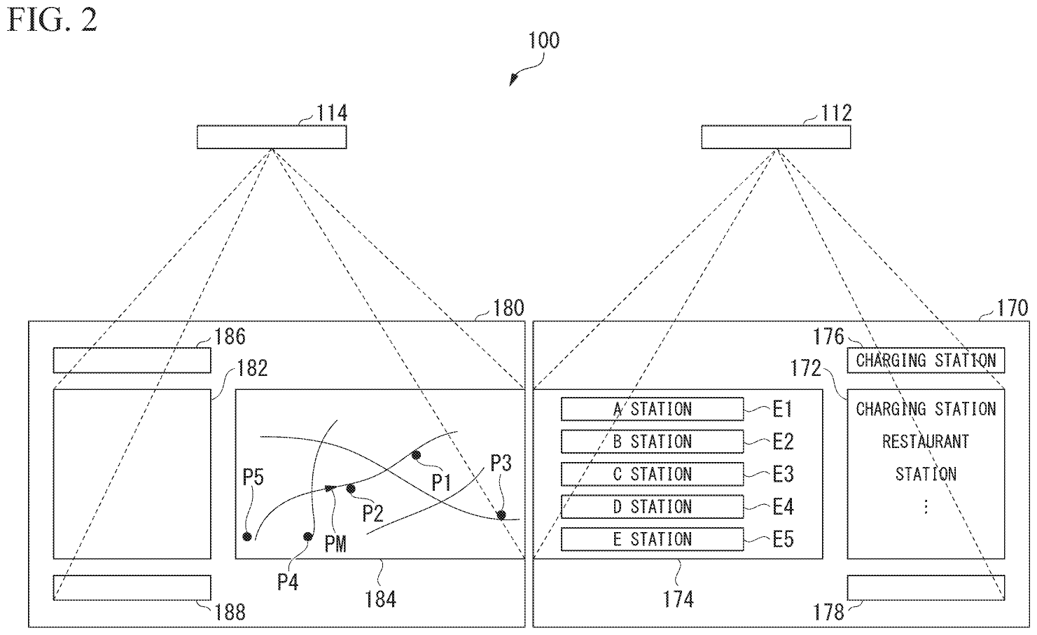

FIG. 2 is a diagram showing an example of a screen displayed on the display device 100. As shown in FIG. 2, a first operation region 172, a first image display region 174, a first selection item display region 176, and a first determination switch 178 are set in the first display 170. The GUI switch is displayed on, for example, the first operation region 172 and the first image display region 174. The first determination switch 178 is a GUI switch. In this state, the first operation region 172, the first image display region 174, and the first determination switch 178 constitute a portion of the first receiver 112

A second operation region 182, a second image display region 184, a second selection item display region 186, and a second determination switch 188 are set in the second display 180. The GUI switch is displayed in, for example, the second operation region 182 and the second image display region 184. The second determination switch 188 is a GUI switch. For example, the first display 170 is installed on the side of a driver's seat or in the center in a dashboard in a vehicle and is disposed at a position closer to the driver's seat than the second display 180. The second display 180 is installed on the side of a seat next to the driver in a vehicle and is disposed at a position closer to the seat next to the driver than the first display 170. In this state, the second operation region 182, the second image display region 184, and the second determination switch 188 constitute a portion of the second receiver 114.

The display controller 130 generates (or acquires) contents including a display image and displays contents on one or both of the first display 170 and the second display 180 on the basis of operation results received by the receiver 110.

In a case where an operation is received by the receiver 110 in a state where contents are displayed on any one of the first display 170 and the second display 180, the display controller 130 changes a display mode of contents displayed in advance in response to the received operation. The “changing a display mode” may include operations such as changing a display position, stopping display, and enlarging or reducing a display region. For example, the display controller 130 may display display contents of the first display 170 on the second display 180 or display display contents previously displayed on the second display 180 on the second display 180 again.

In the case of a right-hand-drive vehicle, the second display 180 is displayed on the left of the first display 170. In the case of a left-hand-drive vehicle, the right and left sides are reversely disposed. Hereinafter, a configuration of a right-hand-drive vehicle will be exemplified, but the right and left sides may be replaced with each other for a configuration of a left-hand-drive vehicle.

[Display Mode of Display Device]

Next, a display mode of the display device 100 will be described. The first operation region 172 of the first display 170 is disposed on a side close to a driver's seat positioned in the center in a height direction, and the first image display region 174 is disposed in a wide region on the left side (a side on a seat next to the driver) of the first operation region 172. The first selection item display region 176 is disposed above the first operation region 172, and the first determination switch 178 is disposed below the first operation region 172.

A plurality of GUI switches serving as operators are displayed in the first operation region 172. The first operation region 172 includes a scene in which an image including an operator is displayed and a scene in which an image not including an operator is displayed. In the example shown in FIG. 2, a plurality of operators are displayed in the first operation region 172, and an item to be selected is displayed in each operator. An image corresponding to an operation of an operator displayed in the first operation region 172, the first image display region 174, or the like is displayed in the first image display region 174. GUI switches serving for a plurality of options (operators) are displayed in the first image display region 174. The first image display region 174 includes a scene in which an image including an operator is displayed and a scene in which an image not including an operator is displayed. In the example shown in FIG. 2, options of a plurality of charging stations are displayed as operators in the first image display region 174. The name of a charging station is displayed in each option. In a case where GUI switches serving as operators are displayed, each of the first operation region 172 and the first image display region 174 functions as a portion of the first receiver 112.

The name of an item selected in the first operation region 172 is displayed in the first selection item display region 176. When an option displayed in the first image display region 174 is temporarily determined, letters of “determination” are displayed in the first determination switch 178. In a case where the first determination switch 178 is operated when letters of “determination” are displayed, an option temporarily determined is finally determined. In a case where letters of “determination” are displayed, the first determination switch 178 functions as a portion of the first receiver 112. An operation of performing temporary determination is an example of an operation in a first mode, and an operation of performing final determination is an example of an operation in a second mode. An operation of performing temporary determination and an operation of performing final determination are not limited to the above-described operations, and may be other operations. For example, the operation of performing final determination may be an operation of selecting a temporarily determined operation again.

Similarly to the first display 170, a display image including the second operation region 182, the second image display region 184, the second selection item display region 186, and the second determination switch 188 is displayed on the second display 180. The second operation region 182, the second image display region 184, the second selection item display region 186, and the second determination switch 188 all function similar to the first operation region 172, the first image display region 174, the first selection item display region 176, and the first determination switch 178 in the first display 170. Although not shown in FIG. 2, operators may be displayed as images in the second operation region 182 and the second image display region 184 similar to the first operation region 172 and the first image display region 174. These operators function as a portion of the second receiver 114. The name of an item selected in the second operation region 182 may be displayed in the second selection item display region 186, and letters of “determination” may be displayed in the second determination switch 188. In a case where letters of “determination” are displayed similar to the first determination switch 178, the second determination switch 188 functions as a portion of the second receiver 114.

In the case of a right-hand-drive vehicle, the first operation region 172 is disposed on the right side of the first display 170 and is operated by a driver more easily than a fellow passenger (a person, and hereinafter, referred to as an “assistant”) who is sitting on a seat next to the driver. In the case of a right-hand-drive vehicle, the second operation region 182 is disposed on the left side of the second display 180 and is operated by an assistant more easily than a driver.

For example, when a navigation device not shown in the drawing navigates a host vehicle to a destination, the display device 100 displays information for determining a destination. Subsequently, the display device 100 displays navigation information for navigating the host vehicle. The navigation information includes map information. In a display mode shown in FIG. 2, various pieces of information are displayed in a situation where a destination of navigation has been determined. For example, the name of contents displayed in the first image display region 174 of the first display 170 is displayed in each operator displayed in the first operation region 172. In the example shown in FIG. 2, the names of items such as a “charging station”, a “restaurant”, and a “station” are displayed in a plurality of operators. These items are items obtained by dividing facilities serving as destinations according to genres. When the receiver 110 receives an operation of selecting these items, the display controller 130 displays list information of the items for which an operation has been accepted in the first image display region 174. An operation of selecting an item displayed in the first operation region 172 is, for example, an operation of an occupant touching an operator in which each item is displayed.

When one of the items displayed in the first operation region 172 is selected and received by the receiver 110, the display controller 130 displays, for example, the received item in the first selection item display region 176. In the state shown in FIG. 2, an item of a charging station is selected from among the items displayed in the first operation region 172. An item of a “charging station” which is selected at present is displayed in the first selection item display region 176 disposed above the first operation region 172.

The display controller 130 displays list information regarding a list of charging stations in the first image display region 174. The display controller 130 displays a plurality of options (operators), for example, five first to fifth options E1 to E5 in the first image display region 174 as list information of the charging stations. As the list information displayed in the first image display region 174, names of a plurality of charging stations in the vicinity of a host vehicle are displayed. For example, letters of an “A station” are displayed in the first option E1, letters of a “B station” are displayed in the second option E2. Letters of a “C station” are displayed in the third option E3, letters of a “D station” are displayed in the fourth option E4, and letters of an “E station” are displayed in the fifth option E5.

The display controller 130 displays any image in the second image display region 184 before receiving an operation of selecting an item in the first operation region 172. In a case where the display controller 130 displays list information of items selected through an operation in the first operation region 172, map information which is relevant information related to a charging station is displayed in the second image display region 184. The display controller 130 displays positions of options displayed in the first image display region 174 by symbols on the map information displayed in the second image display region 184.

The position of the host vehicle is shown by a host vehicle mark PM on the map information displayed in the second image display region 184, and the positions of charging stations which are options displayed in the list information are shown by a first symbol P1 to a fifth symbol P5. The host vehicle mark PM may not be displayed. The first symbol P1 indicates the position of an A station, and the second symbol P2 indicates the position of a B station. The third symbol P3 indicates the position of a C station, the fourth symbol P4 indicates the position of a D station, and the fifth symbol P5 indicates the position of an E station. In this manner, the display controller 130 displays positional information of all of the charging stations included in the list information in the second image display region 184. The display controller 130 may display positional information of some of the charging stations included in the list information in the second image display region 184. These first to fifth symbols P1 to P5 may be displayed by, for example, numbered flags.

In a case where the receiver 110 receives an operation of selecting an option of the list information displayed in the first image display region 174 (selection operation), the display controller 130 temporarily determines the selected option. The option selected through an operation of selecting an option of the list information is an “option selected in a first mode”. An operation of selecting an option (an operation of temporarily determining an option) may be, for example, an operation of an occupant of a vehicle who touches an option in the first image display region 174 or may be, for example, an operation of displaying a cursor moving between options and superimposing the cursor on an option. In the latter case, a state where the cursor is superimposed on an option is a temporarily selected state. In a case where an option is temporarily determined, the display controller 130 highlights a symbol indicating the position of a charging station corresponding to the temporarily determined option in the second image display region 184. The highlighting may be performed in any mode. For example, a target to be highlighted may be lit up or enlarged (or thickened), or the shape thereof may be changed.

In a case where the receiver 110 receives an operation of selecting an option different from a temporarily determined option, the display controller 130 changes the temporarily determined option to an option on which an operation has currently been performed. In a case where a selected option is changed, the display controller 130 changes a symbol to be highlighted to a symbol indicating the position of a charging station corresponding to the changed option in the second image display region 184.

When the receiver 110 receives an operation of selecting an option displayed in the first image display region 174, receives an operation of the first determination switch 178, or the like, the display controller 130 changes the display of the first display 170 and the second display 180. Hereinafter, processing in the display controller 130 will be described.

[Processing Flow]

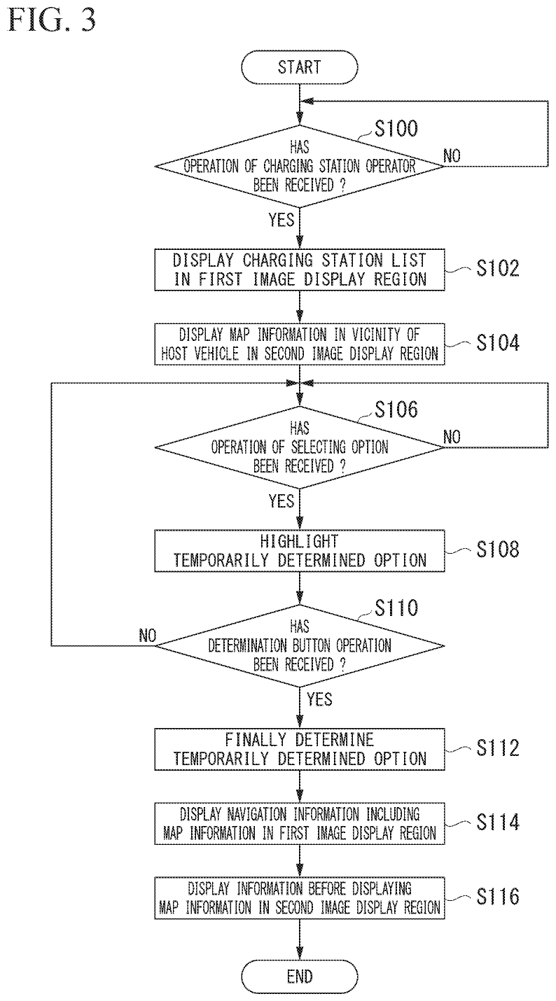

Next, a processing flow in the display device 100 will be described. FIG. 3 is a flowchart showing an example of a flow of processing executed in the display device 100. The following flowchart is executed after a power supply of the display device 100 is turned on and map information is displayed in the first image display region 174. In the following flowchart, processing from the determination of a charging station which is a destination at the time of navigating a host vehicle using a navigation device to the start of navigation will be described.

The display controller 130 causes the receiver 110 to receive an operation of selecting an operator of a charging station displayed in the first operation region 172. Subsequently, the display controller 130 determines whether or not an operation of displaying an item of a charging station in the first image display region 174 has been performed (step S100). In a case where the receiver 110 has not received an operation of selecting an operator of a charging station, the display controller 130 repeats the process of step S100 until the receiver 110 receives an operation of selecting an operator of a charging station. In a case where the receiver 110 has received an operation of selecting an operator of another item before an operation of selecting an item of a charging station is performed, the display controller 130 performs a process corresponding to a case where an operation of selecting an operator of another item has been received.

In a case where the receiver 110 has received an operation of selecting an operator of a charging station, the display controller 130 displays list information of charging stations in the first image display region 174 (step S102). Next, the display controller 130 displays map information regarding the surroundings of the host vehicle in the second image display region 184 (step S104). Subsequently, the display controller 130 determines whether or not the receiver 110 has received an operation of selecting an option displayed in the first image display region 174 (step S106).

In a case where the receiver 110 has not received an operation of selecting an option displayed in the first image display region 174, the display controller 130 repeats the process of step S106. In a case where the receiver 110 has received an operation of selecting an option displayed in the first image display region 174, the display controller 130 temporarily determines the option for which the selection operation has been accepted and highlights the option (step S108).

Next, the display controller 130 determines whether or not the receiver 110 has received an operation of the first determination switch 178 (step S110). In a case where the receiver 110 has not received an operation of the first determination switch 178, the display controller 130 returns to step S108. In a case where the receiver 110 has received an operation of the first determination switch 178, the display controller 130 finally determines the temporarily determined option (step S112).

The display controller 130 displays navigation information including map information in the first image display region 174 (step S114). The navigation information is information in which the position of the host device and the position of a charging station corresponding to the finally determined option are displayed in the map information. The navigation information is displayed in the first image display region 174, and thus navigation using the navigation device is started. Subsequently, the display controller 130 displays information displayed before displaying map information in the second image display region 184 in step S104 in the second image display region 184 (step S116). In this manner, the display device 100 terminates the processing shown in FIG. 3.

[Change in Display Mode of Display Device]

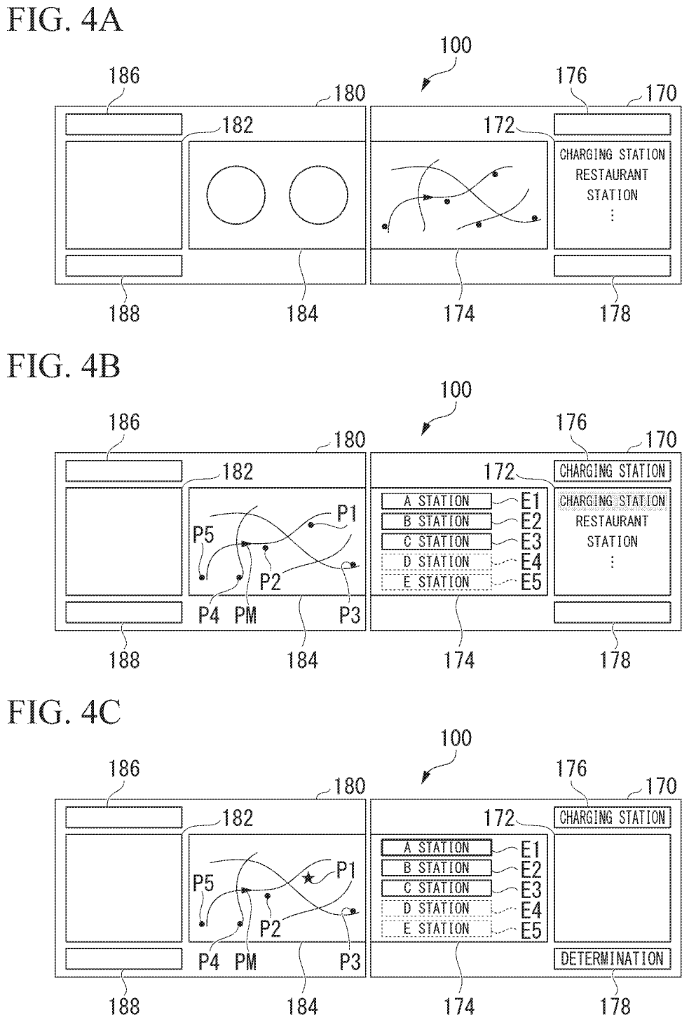

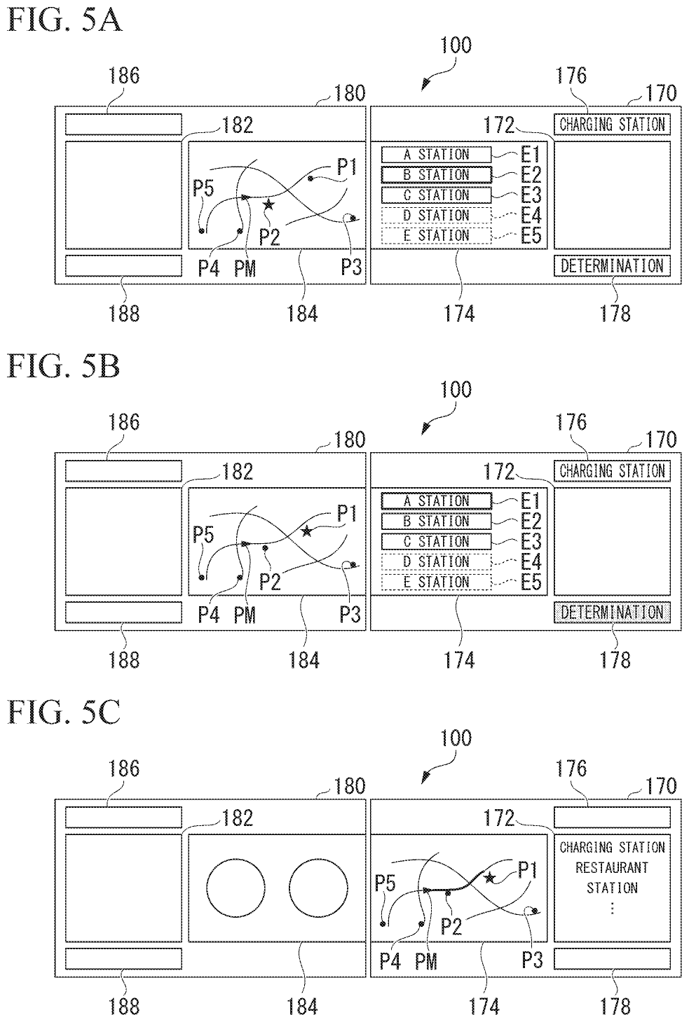

Next, a change in a display mode of the display device 100 will be described. FIGS. 4A to 4C and 5A to 5C are diagrams showing an example of a change in a display mode of the display device 100. As shown in FIG. 4A, before an operation of selecting operators such as a “charging station”, a “restaurant”, and a “station” displayed in the first operation region 172 is performed, the display controller 130 displays map information in the first image display region 174, provides information regarding the surroundings of a host vehicle to a driver, and helps the driver's driving. The display controller 130 displays any image, for example, an image providing information preferred by an assistant in the second image display region 184. Information to be displayed in the first operation region 172 is not limited to items such as a “charging station”, a “restaurant”, and a “station” and may be other information. For example, information to be displayed in the first operation region 172 may be an option of an in-vehicle function, for example, an option of an application usable in a vehicle, or the like. In this case, information regarding charging stations, for example, an application for displaying the locations of charging stations may be included in options.

Next, when an operator indicating an item of a “charging station” displayed in the first operation region 172 is operated by a driver and the receiver 110 receives the operation, the display controller 130 darkens the selected operator of a “charging station” as shown in FIG. 4B. In this case, the operator of a “charging station” may not be darkened. The display controller 130 displays the “charging station” which is the selected item in the first selection item display region 176 and displays list information of charging stations in the first image display region 174. The list information includes a plurality of options. Information may not be displayed in the first selection item display region 176.

The display controller 130 displays options of the first option E1 to the fifth option E5 as list information. After the options of the first option E1 to the fifth option E5 are displayed on the first display 170, the display controller 130 erases the display of the first operation region 172 and displays letters of “determination” in the first determination switch 178 as shown in FIG. 4C. Although an example in which the first option E1 at the top of the list is temporarily selected is shown in FIG. 4C, a state where the first option is not temporarily selected may be set until a user performs an operation.

In this case, the display controller 130 displays an option corresponding to a charging station assumed to be located ahead of the host device that will now be traveled to (hereinafter, referred to as a “target charging station”) brightly. The display controller 130 displays an option corresponding to a charging station on a road on which the host vehicle has passed or on a road on which the host vehicle cannot pass without turning back (hereinafter, referred to as a “non-target charging station”) darkly. For example, the display controller 130 sets charging stations within a distance less than a predetermined distance from the host vehicle as target charging stations and non-target charging stations, and excludes charging stations in a range equal to or greater than a predetermined distance from list information.

In the example shown in FIG. 4B, an A station, a B station, and a C station are target charging stations, and a D station and an E station are non-target charging stations. The display controller 130 displays the first option E1, the second option E2, and the third option E3 respectively indicating the A station, the B station, and the C station brightly and displays the fourth option E4 and the fifth option E5 respectively indicating the D station and the E station darkly. The display controller 130 acquires a traveling history and a traveling schedule of the host vehicle from, for example, a navigation device not shown in the drawing and determines a non-target charging station on the basis of the traveling history of the host vehicle. A target charging station is determined on the basis of the traveling schedule of the host vehicle. The display device 100 may divide all charging stations displayed in the first operation region 172 into target charging stations and non-target charging stations or may divide the charging stations into target charging stations and non-target charging stations in a range in which they can be classified.

The display controller 130 displays map information in the second image display region 184 and displays the positions of the charging stations using the first symbol P1 to the fifth symbol P5. The display controller 130 displays the first symbol P1 to the fifth symbol P5 in a similar mode, but may display, for example, symbols indicating the positions of a target charging station and a non-target charging station in different modes. In this case, for example, the display controller 130 may display a symbol indicating a target charging station brightly and may display a symbol indicating a non-target charging station darkly. An option or a symbol indicating a non-target charging station may not be displayed.

Next, when a driver operates one of a plurality of options displayed in the first image display region 174, for example, the first option E1 of the “A station” and the receiver 110 receives the operation, the display controller 130 temporarily determines the “A station”. Subsequently, the display controller 130 highlights the first option E1 displayed in the first image display region 174 as shown in FIG. 4C. Further, the display controller 130 highlights the first symbol P1 indicating the position of the A station among the plurality of symbols displayed in the second image display region 184. The display controller 130 highlights the first option E1 to indicate to a driver that the A station shown in the first option E1 has been temporarily determined. The display controller 130 emphasizes the first symbol P1 to indicate the position of the temporarily determined A station so as to be easily recognized by a driver. The display controller 130 erases an operator of each item displayed in the first operation region 172. For this reason, an item is not selected from the first operation region 172. An operator of each item displayed in the first operation region 172 may be kept displayed. In FIG. 4C, in a state where a user does not perform an operation and temporary selection is not performed, display similar to those for the other second to fifth symbols P2 to P5 may be performed without highlighting such as for the first symbol P1 in the second image display region 184.

Next, for example, when a driver operates an option indicating the “B station” displayed in the first image display region 174 and the receiver 110 receives the operation, the display controller 130 changes a temporarily determined charging station from the “A station” to the “B station”. In this case, the display controller 130 terminates the highlighting of the first option E1 displayed in the first image display region 174 and highlights the second option E2 as shown in FIG. 5A. The display controller 130 terminates the highlighting of the first symbol P1 displayed in the second image display region 184 and highlights the second symbol P2. In this manner, the display controller 130 indicates to the driver that the temporarily determined charging station has been changed.

Thereafter, for example, when the driver operates the first determination switch 178 and the receiver 110 receives the operation in the state shown in FIG. 4C, the display controller 130 darkens the first determination switch 178 as shown in FIG. 5B. In this case, the first determination switch 178 may not be darkened. In this case, the display controller 130 finally determines the “A station” as a charging station which is a destination of the host vehicle.

After the “A station” is finally determined, the display controller 130 displays the host vehicle mark PM which is information displayed in the second image display region 184 and map information having the first to fifth symbols P1 to P5 displayed therein in the first image display region 174 as navigation information as shown in FIG. 5C. The display controller 130 displays an operator (see FIG. 4B) of each item displayed in the first operation region 172 in the first operation region 172 and erases the display of the first selection item display region 176 and the first determination switch 178. In addition, the display controller 130 highlights an image indicating a road from the host vehicle mark PM to the first symbol P1. The display controller 130 displays information displayed before map information is displayed in the second image display region 184 (information shown in FIG. 4A) in the second image display region 184. The display controller 130 returns the display of the first operation region 172, the first image display region 174, and the first determination switch 178 to the state shown in FIG. 4A. In this manner, a series of display operations of the display device 100 is performed. In the above-described example, the display controller 130 displays a host vehicle mark and symbols in map information displayed in the second image display region 184 in FIG. 4B, but a host vehicle mark and symbols may not be displayed yet in this stage. In this case, for example, when map information is displayed in the first image display region 174, the map information may be displayed as navigation information. In this case, information to be displayed in the first operation region 172 may be information of options of applications usable in a vehicle, or the like.

In this manner, in a case where one of the first to fifth options E1 to E5 included in list information displayed on the first display 170 is selected and temporarily determined, the display device 100 of the first embodiment displays map information and the position of a charging station of the selected option on the second display 180. For this reason, information can be displayed by sufficiently utilizing the first display 170 and the second display 180 which are two displays.

In the display device 100 of the first embodiment, list information is displayed on the first display 170 which is close to a driver, and thus operability when the driver operates an option of the list information and visibility of the list information are improved. The display device 100 of the first embodiment receives an operation of the first determination switch 178 after one of the first to fifth options E1 to E5 included in the list information displayed on the first display 170 is selected and temporarily determined to display map information and the like displayed in the second image display region 184 in the first image display region 174. For this reason, it is possible to allow the driver to easily use the function of the first display 170.

When there are a plurality of displays such as the first display 170 and the second display 180, a display that is easy to use and a display which is easily viewed vary depending on a boarding position of an occupant in a vehicle. For example, it is important for a driver to view list information in order to select an option included in the list information before finally determining an option (charging station) and to view map information regarding selected contents after an option is finally determined. In this regard, in the display device 100 of the first embodiment, for example, in a case where list information is displayed on the first display 170 through the driver's operation, the list information is displayed on the first display 170 before an option (charging station) is finally determined, and the display in the first image display region 174 is changed from the list information to map information after an option is finally determined. Therefore, information suitable for an occupant such as a driver can be displayed on the display 170 and the second display 180.

In the display device 100 of the first embodiment, the first operation region 172, the first image display region 174, the first selection item display region 176, and the first determination switch 178 are provided in the first display 170 disposed on a side close to a driver's seat. For this reason, it is possible to allow a driver sitting on the driver's seat to easily view the display of these and easily operate switches included in the display of these. Further, in the display device 100 of the first embodiment, the second operation region 182, the second image display region 184, the second selection item display region 186, and the second determination switch 188 are provided in the second display 180 disposed on a side close to a seat next to the driver. For this reason, similarly to the driver, it is also possible to allow an assistant sitting on the seat next to the driver to easily view the display of these and easily operate switches included in the display of these.

In the display device 100 of the first embodiment, options displayed in the switches, for example, the first operation region 172, the first image display region 174, the second operation region 182, and the second image display region 184, the first determination switch 178, and the second determination switch 188 are formed by a GUI, but operation buttons and the like other than the GUI may be used instead of the GUI. For example, the operation buttons other than the GUI may be disposed around the vicinity of the display device 100 or may be displayed on the inner side of the display device 100. In a case where operation buttons are disposed around the display device 100, the operation buttons may be disposed at any location such as the right side (a side of a driver's seat), the left side (a side of a seat next to the driver), the upper side, or the lower side of the display device 100.

In the display device 100 of the first embodiment, after map information and the like displayed in the second image display region 184 in the first image display region 174, information displayed in the second image display region 184 before displaying the map information is displayed in the second image display region 184. For this reason, after the position of a charging station is displayed, information originally displayed in the second image display region 184 is displayed, and thus, for example, operability is improved and information preferred by an assistant can be displayed on the second display 180.

In the display device 100 of the first embodiment, charging stations are divided into target charging stations in the vicinity of a traveling path in which a vehicle is scheduled to travel and non-target charging stations at locations other than the vicinity of the traveling path in which the vehicle is scheduled to travel, and a target charging station is selected from among the target charging stations. For this reason, it is possible to make it difficult to cause insufficient charging of a host vehicle.

In the display device 100 of the first embodiment, since a host vehicle is an electric car, a charging station serves as an energy supply station, and an energy supply station may be set to be an option. However, an energy supply station may vary depending on the type of host vehicle. For example, in a case where a host vehicle is a gasoline car, a gas station may be used as an energy supply station, or a hydrogen station may be used as an energy supply station in the case of a fuel cell vehicle.

Regarding an option such as a charging station, additional information of an option may be displayed together. Examples of the additional information of an option may include information such as use conditions (whether a charging station is empty or full, an estimated waiting time, and the like), capacity (how many vehicles can be charged at the same time), user evaluation (rating), an external appearance image of a charging station, and the like, for example, in the case of a charging station. In addition, the unit price of gasoline may be used as additional information when an option is a gas station, and information such as a menu or an average customer unit price may be used as additional information when an option is a restaurant. For example, additional information may be displayed on either the first display 170 or the second display 180 in the display device 100, may be displayed together with, for example, map information, or may be displayed together with list information. Additional information may be displayed separately from these pieces of information. Options displayed in the first operation region 172, the first image display region 174, the second operation region 182, and the second image display region 184 and additional information of these options may be selectable by operating a toggle.

### Second Embodiment

Next, a second embodiment of the present invention will be described. In the display device 100 of the first embodiment, after a destination is determined using a navigation device and navigation information is displayed in the first image display region 174, information displayed in the second image display region 184 before displaying map information is displayed in the second image display region 184. On the other hand, in a display device 100 of the second embodiment, after a destination is determined using a navigation device and navigation information is displayed in the first image display region 174, list information displayed in the first image display region 174 is displayed in the second image display region 184.

[Processing Flow]

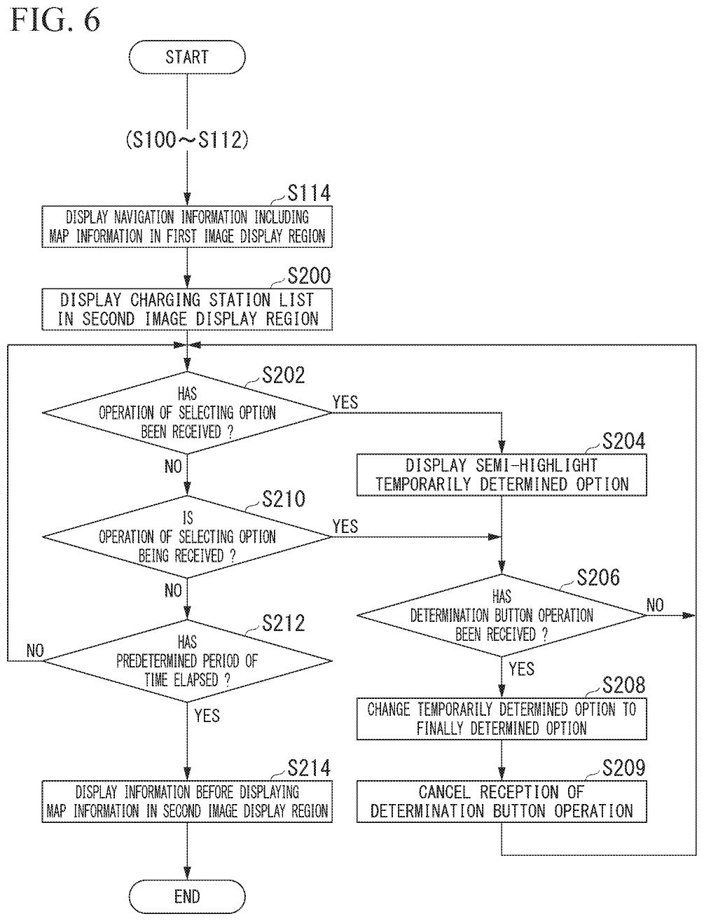

Hereinafter, processing and a change in a display mode of the display device 100 of the second embodiment will be described. FIG. 6 is a flowchart showing an example of a flow of processing executed in display device 100 of the second embodiment. The following flowchart is executed after a power supply of the display device 100 is set to be in an on state and map information is displayed in a first image display region 174, similar to the first embodiment.

Immediately after map information is displayed in the first image display region 174, the display device 100 executes processing from step S100 to step S114 in the flowchart shown in FIG. 3 which is common to the above-described first embodiment. When this processing is outlined below, a display controller 130 determines whether or not an operator of a charging station displayed in a first operation region 172 has been selected and an operation of selecting an item of a charging station has been performed (step S100). In a case where an operation of selecting an item of a charging station has been performed, list information of a charging station is displayed in the first image display region 174 (step S102), and map information of the surroundings of a host vehicle is displayed in the second image display region 184 (step S104). Subsequently, the display controller 130 determines whether or not a receiver 110 has received an operation of selecting an option displayed in the first image display region 174 (step S106). In a case where the receiver 110 has received an operation of selecting an option displayed in the first image display region 174, the selected option is temporarily determined and highlighted (step S108). Next, the display controller 130 determines whether or not the receiver 110 has received an operation of a first determination switch 178 (step S110). In a case where the receiver 110 has received an operation of the first determination switch 178, the temporarily determined option is finally determined (step S112). The display controller 130 displays navigation information including map information in the first image display region 174 (step S114). Processing so far is the same processing as in the first embodiment.

Next, the display controller 130 displays list information of charging stations displayed in the first image display region 174 in a second image display region 184 (step S200). In this manner, it is possible to easily change a destination using a navigation device by displaying navigation information in the first image display region 174 and then displaying the list information of charging stations in the second image display region 184. When the list information is displayed in the second image display region 184, letters of a “charging station” are displayed in a second selection item display region 186, and letters of a “determination” are displayed in a second determination switch 188.

Next, the display controller 130 determines whether or not the receiver 110 has received an operation of selecting an option displayed in the second image display region 184 (step S202). In a case where it is determined that the receiver 110 has received an operation of selecting an option displayed in the second image display region 184, the display controller 130 temporarily determines the selected option and semi-highlights the option (step S204). The semi-highlighting is a display mode weaker than highlighting.

Next, the display controller 130 determines whether or not the receiver 110 has received an operation of the second determination switch 188 (step S206). In a case where the receiver 110 has not received an operation of the second determination switch 188, the display controller 130 returns to step S202. In a case where the receiver 110 has received an operation of the second determination switch 188, the display controller 130 changes a temporarily determined option to a finally determined option (step S208). In this case, the final determination of the option that has already been determined finally is canceled. Subsequently, the display controller 130 cancels the reception of an operation of selecting an option displayed in the second image display region 184 by the receiver 110 (step S209), and returns to step S202.

In step S202, in a case where it is determined that the receiver 110 has not received an operation of selecting an option displayed in the second image display region 184, the display controller 130 determines whether or not an operation of selecting an option displayed in the second image display region 184 is being received (step S210). In step S202, in a case where it is determined that the receiver 110 has received an operation of selecting an option displayed in the second image display region 184 or it is determined that the reception of the receiver 110 that has once received an operation is not canceled in step S210 and a selected operation is being received, the display controller 130 proceeds to step S206.

In a case where it is determined that the receiver 110 has never received an operation of selecting an operation displayed in the second image display region 184 or it is determined that the reception of the receiver 110 that has once received an operation is canceled in step S210 and a selected operation is not being received, the display controller 130 determines whether or not a predetermined period of time, for example, 30 seconds has elapsed after list information is displayed in the second image display region 184 (step S212). The predetermined period of time may be any period of time. The predetermined period of time is set to 30 seconds in the second embodiment, but may be set to a period of time shorter than 30 seconds, for example, 5 seconds, 10 seconds, 15 seconds, or the like, or may be set to a period of time longer than 30 seconds, for example, 60 seconds or the like. The predetermined period of time may be able to be determined by an occupant such as a driver. In this manner, the display device 100 of the second embodiment displays list information displayed in the first image display region 174 in the second image display region 184 until a predetermined period of time elapses.

In a case where it is determined that a predetermined period of time has not elapsed, the display controller 130 returns to step S202. In a case where it is determined that a predetermined period of time has elapsed, the display controller 130 displays information displayed before displaying map information in the second image display region 184 in step S104 in the second image display region 184 (step S214). In this manner, in a case where an operation of selecting an option displayed in the second image display region 184 is not received by the receiver 110 for a predetermined period of time, the display device 100 of the second embodiment displays information displayed before displaying map information in the second image display region 184 in step S104 in the second image display region 184. In this manner, the display device 100 terminates the processing shown in FIG. 6.

[Change in Display Mode of Display Device]

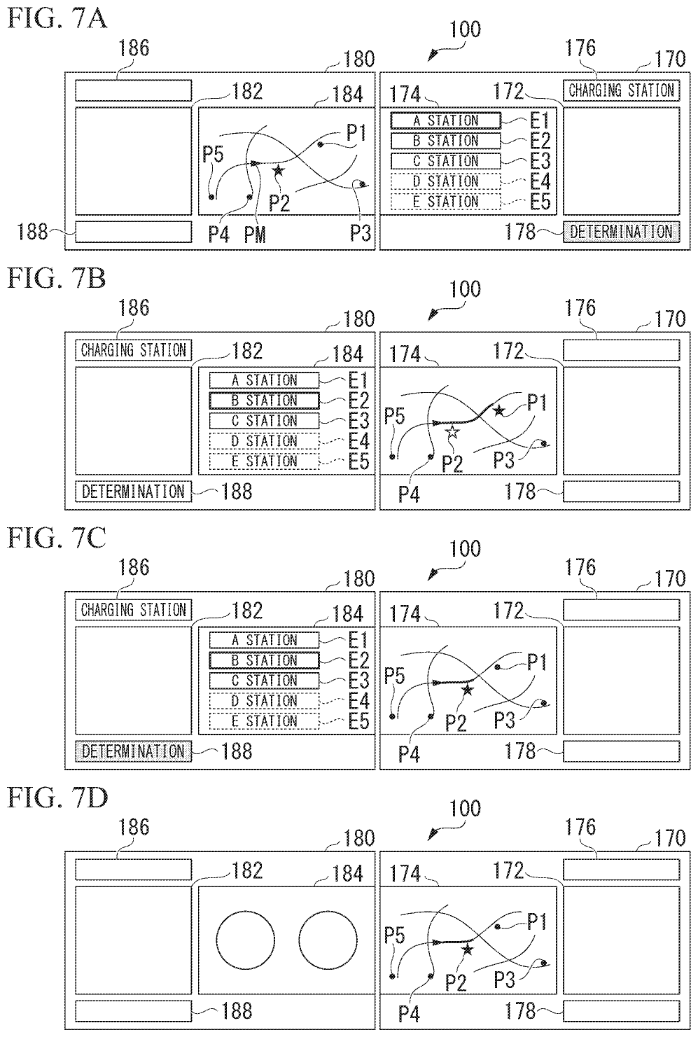

Next, a change in a display mode of the display device 100 of the second embodiment will be described. FIG. 7A to 7D is a diagram showing an example of a change in a display mode of the display device 100. FIG. 7A shows a display mode of the display device 100 when the receiver 110 receives an operation of the first determination switch 178 and finally determines an operation of an A station which is temporarily determined by the display controller 130 in step S212. In this case, list information of charging stations is displayed in the first image display region 174, and map information is displayed in the second image display region 184. The display device 100 performs display having changed in a similar manner to the display modes shown in FIGS. 4A to 4C and 5A to 5C until an image shown in FIG. 7A is displayed.

When the first determination switch 178 is operated, the display controller 130 displays navigation information including map information in the first image display region 174 as shown in FIG. 7B, similar to the first embodiment. In this case, in the first embodiment, as shown in FIG. 5C, the display controller 130 displays information displayed before displaying map information in the second image display region 184 in the second image display region 184. On the other hand, in the second embodiment, as shown in FIG. 7B, the display controller 130 displays list information of charging stations in the second image display region 184. Letters of a “charging station” are displayed in the second selection item display region 186, and letters of “determination” are displayed in the second determination switch 188.

Similarly to the first image display region 174 in which list information is displayed, the second image display region 184 having list information displayed therein functions as a receiver (second receiver 114). The second determination switch 188 having letters of “determination” displayed therein functions as a receiver (second receiver 114), similar to the first determination switch 178 in which letters of “determination” are displayed. In a case where the receiver 110 has received an operation for an option of the second image display region 184 in which list information is displayed, the display controller 130 temporarily determines the operated option. In a case where the receiver 110 has received an operation of the second determination switch 188 in which letters of “determination” are displayed, the display controller 130 finally determines the temporarily determined option.

For example, when a driver operates one of a plurality of options displayed in the second image display region 184, for example, a second option E2 of a “B station” before a predetermined period of time elapses after list information is displayed in the second image display region 184 and the receiver 110 receives the operation, the display controller 130 temporarily determines the “B station”. In this case, a second symbol P2 displayed in the first image display region 174 is highlighted. Subsequently, as shown in FIG. 7B, the display controller 130 highlights the second option E2 displayed in the second image display region 184. Further, the display controller 130 semi-highlights the second symbol P2 indicating the position of the B station among a plurality of symbols displayed in the first image display region 174.

Thereafter, for example, when an assistant operates the second determination switch 188 in the state shown in FIG. 7B and the receiver 110 receives the operation, the display controller 130 darkens the second determination switch 188 as shown in FIG. 7C. In this case, the second determination switch 188 may not be darkened. In this case, the display controller 130 changes an option which is finally determined as a charging station which is a destination of the host vehicle from the “A station” to the “B station”.

The display controller 130 changes the finally determined option to the “B station”, cancels the highlighting of the first symbol P1 displayed in the first image display region 174, and changes the semi-highlighting of the second symbol P2 to highlighting. In addition, the display controller 130 changes an image in which a road from a host vehicle mark PM to the first symbol P1 is highlighted to an image in which a road from the host vehicle mark PM to the second symbol P2 is highlighted and displays the changed image.

Thereafter, when a predetermined period of time elapses, the display controller 130 displays information (information shown in FIG. 4A) displayed before displaying map information in the second image display region 184 in the second image display region 184 as shown in FIG. 7D. In this manner, a series of display operations of the display device 100 is performed.

In this manner, the display device 100 of the second embodiment displays the navigation information including map information in the first image display region 174 and then displays the list information displayed in the first image display region 174 in the second image display region 184. For this reason, an operation can be selected again by operating the list information in the second image display region 184. Therefore, for example, it is possible to easily select an operation again after an operation included in the list information is erroneously selected, or the like.

In the display device 100 of the second embodiment, a display time of list information displayed in the second image display region 184 is set to 30 seconds in the second embodiment. For this reason, a situation where list information is displayed over a long period of time can be curbed, and thus it is possible to contribute effective utilization of the display device 100 in a case where selection is not performed again.

In the display device 100 of the second embodiment, information which is originally displayed in the second image display region 184 is displayed after list information displayed in the second image display region 184 is erased, and thus it is possible to, for example, contribute to an improvement in operability and display information preferred by an assistant on the second display 180.

In the second embodiment, after a predetermined period of time elapses from the display of list information in the second image display region 184, the list information in the second image display region 184 is erased. The display controller 130 sets the time when the list information is displayed in the second image display region 184 to be a measurement start timing of a predetermined period of time, but the measurement start timing of the predetermined period of time may be another timing or may be, for example, the time when navigation information is displayed in the first image display region 174.

In a case where an operation for the first display 170 or the second display 180 is received after list information is displayed in the second image display region 184, the time when the operation is received may be set to be a measurement start timing of a predetermined period of time. The predetermined period of time may vary depending on the measurement start timing. For example, a predetermined period of time clocked after list information is displayed in the second image display region 184 is 30 seconds, while a predetermined period of time clocked after an operation of list information displayed in the second image display region 184 may be set to be 60 seconds.

In the second embodiment, list information in the second image display region 184 is erased after a predetermined period of time elapses after list information is displayed in the second image display region 184, but the list information may be erased under other conditions. For example, list information in the second image display region 184 may be erased when a vehicle first stops after the display of the list information in the second image display region 184 is started.

In the second embodiment, in a case where map information or navigation information including map information is displayed on the first display 170 disposed on a side close to a driver's seat, the map information or the navigation information is continuously displayed in a case where an option of list information displayed on the second display 180 is operated. For this reason, a state where a driver can easily view map information and the like useful for the driver's driving can be continued.

In the second embodiment, map information which is information useful for a driver is continuously displayed on the first display 170 which is a display on a side close to the driver's seat. On the other hand, for example, information useful for an assistant, for example, information such as an option for selecting a piece of audio music may be displayed. In this case, information useful for an assistant may be continuously displayed on the second display 180 which is a display on a side close to a seat next to the driver.

### Third Embodiment

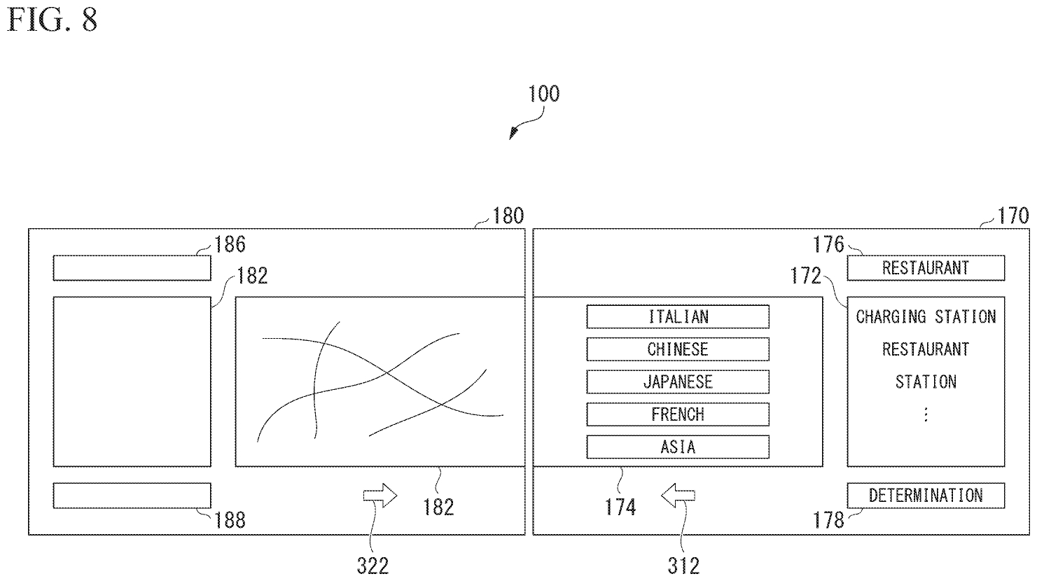

Next, a third embodiment of the present invention will be described. A display device 100 of the third embodiment is different from that of the first embodiment in that a first screen conversion switch 312 is displayed below a first image display region 174, and a second screen conversion switch 322 is displayed below a second image display region 184, as shown in FIG. 8. Both the first screen conversion switch 312 and the second screen conversion switch 322 are GUI switches. The first screen conversion switch 312 and the second screen conversion switch 322 may be switches other than GUI switches. The first screen conversion switch 312 and the second screen conversion switch 322 may be, for example, switches provided in the vicinity of the display device 100 or may be detection means for detecting a gesture exclusively for exchange performed by a driver or the like. When a receiver 110 receives an exchange instruction operation by operating the first screen conversion switch 312 or the second screen conversion switch 322, the display controller 130 exchanges and replaces the display in a first operation region 172, the first image display region 174, a first selection item display region 176, and a first determination switch 178 of the first display 170 and the display of a second operation region 182, the second image display region 184, a second selection item display region 186, and a second determination switch 188 of the second display 180 with each other. In the other respects, configurations are similar to the above-described first embodiment.

[Processing Flow]

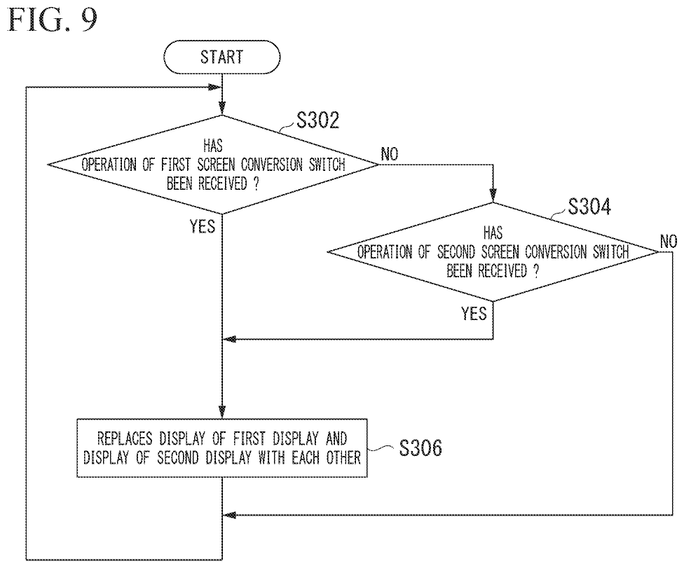

Hereinafter, processing and a change in a display mode of the display device 100 of the third embodiment will be described. FIG. 9 is a flowchart showing an example of a flow of processing executed in the display device 100 of the third embodiment. Since the following flowchart is executed after a power supply of the display device 100 is set to be in an on state, the flowchart is basically executed continuously during the operation of a system of the display device 100 and is terminated when the power supply is set to be in an off state.

The display controller 130 determines whether or not the receiver 110 has received an operation of the first screen conversion switch 312 (step S302). In a case where it is determined that the receiver 110 has not received an operation of the first screen conversion switch 312, the display controller 130 determines whether or not the receiver 110 has received an operation of the second screen conversion switch 322 (step S304).

In a case where it is determined that the receiver 110 has not received an operation of the second screen conversion switch 322, the display device 100 terminates processing shown in FIG. 9. In a case where it is determined in step S302 that the receiver 110 has received an operation of the first screen conversion switch 312 or in a case where it is determined in step S304 that the receiver 110 has received an operation of the second screen conversion switch 322, the display controller 130 replaces display contents of the first display 170 and display contents of the second display with each other (step S306). Thereafter, the display device 100 returns to step S302 and repeats the process of step S302.

[Change in Display Mode of Display Device]

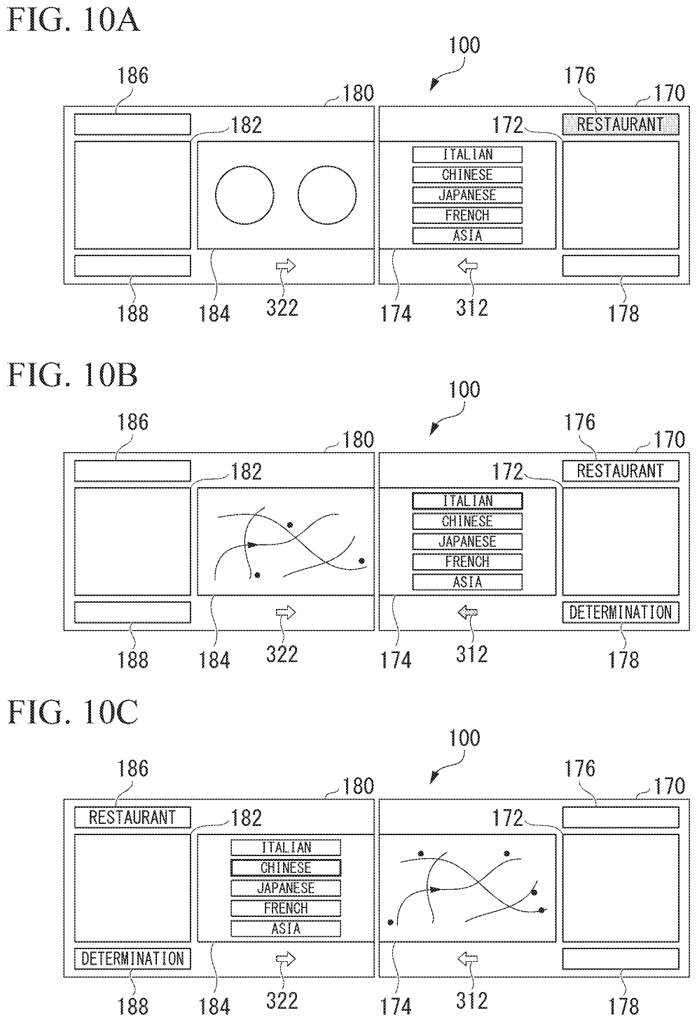

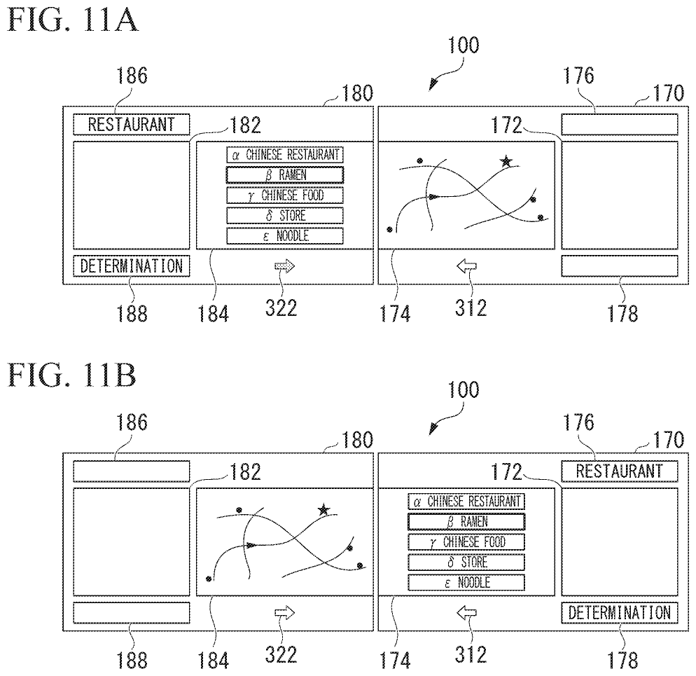

Next, a change in a display mode of the display device 100 of the third embodiment will be described. FIGS. 10A to 10C and 11A to 11B are diagrams showing an example of a change in a display mode of the display device 100 of the third embodiment. FIG. 10(A) shows a state where the receiver 110 has received an operation of an operator of an item of “restaurant” (see FIG. 8) displayed in the first operation region 172. A situation where an occupant of a vehicle is searching for a restaurant to go to a meal.

For example, when a driver operates an operator of an item of “restaurant” displayed in the first operation region 172 in order to search for a restaurant and the receiver 110 receives the operation, the display controller 130 is a restaurant selection application as shown in FIG. 10A and displays list information for each genre of a restaurant in the first image display region 174. In this case, the display controller 130 displays any image, for example, an image for providing information preferred by an assistant in the second image display region 184. The information displayed in the first operation region 172 may be an option of an in-vehicle function, or the like.

Subsequently, it is assumed that the driver first operates an option displayed in the first image display region 174 in order to search for an Italian restaurant and the receiver 110 receives the operation. In this case, as shown in FIG. 10B, the display controller 130 highlights the operated option and displays letters of “determination” in the first determination switch 178. The display controller 130 displays map information having a symbol indicating the position of a restaurant of an option displayed therein in the second image display region 184.

In this state, for example, it is assumed that a driver desires to leave an assistant with an operation of searching for a restaurant in order to concentrate on driving and has operated the first screen conversion switch 312. When the receiver 110 receives the operation of the first screen conversion switch 312, the display controller 130 displays list information for each genre of a restaurant displayed in the first image display region 174 and map information displayed in the second image display region 184 as shown in FIG. 10B in the second image display region 184 and the first image display region 174, respectively, as shown in FIG. 10C. In this manner, as shown in FIG. 10C, the display controller 130 erases contents displayed in the first selection item display region 176 and the first determination switch 178 as shown in FIG. 10B and displays the contents in the second selection item display region 186 and the second determination switch 188.

Thereafter, for example, it is assumed that a driver and an assistant have determined to have Chinese food for a meal through consultation and the assistant has operated an option of “Chinese” displayed in the second image display region 184. Subsequently, when the assistant operates the second determination switch 188 and the receiver 110 receives these operations, the option of “Chinese” is finally determined. Next, as shown in FIG. 11A, the display controller 130 displays list information regarding a store of a “Chinese” restaurant in the second image display region 184.

Here, for example, in the case of a Chinese restaurant, it is assumed that it can be seen that there is a driver's preferred store and a situation where the driver may select the preferred store is set. In this case, when an assistant operates the second screen conversion switch 322 and the receiver 110 receives the operation, the display controller 130 displays list information regarding a store of a “Chinese” restaurant displayed in the second image display region 184 and map information displayed in the first image display region 174 as shown in FIG. 11A in the first image display region 174 and the second image display region 184, respectively, as shown in FIG. 11B. As shown in FIG. 11A, the display controller 130 erases contents displayed in the second selection item display region 186 and the second determination switch 188 as shown in FIG. 11B and displays the contents in the first selection item display region 176 and the first determination switch 178, respectively. In this manner, it is possible to allow the driver to easily search for his or her preferred stores.

In this manner, the display device 100 of the second embodiment operates the first screen conversion switch 312 or the second screen conversion switch 322 to exchange display contents of the first display 170 and display contents of the second display 180 with each other. For this reason, it is possible to easily share information between a driver and an assistant and to replace a screen displaying information suitable for an operation in accordance with situations, knowledge, or the like of the driver and the assistant. Therefore, it is possible to display information suitable for a situation of an occupant. Since an opportunity for a driver and an assistant to view the first display 170 or the second display 180 located at a distant position can be reduced, the driver and the assistant can visually recognize a screen on which useful information is displayed in a state where it is difficult to force an unreasonable system or reduce attention of driving.

The first screen conversion switch 312 for exchanging information of the first display 170 and the second display 180 is disposed on a side close to a driver's seat, and the second screen conversion switch 322 is disposed on a side close to a seat next to the driver. For this reason, it is possible to allow both a driver sitting on a driver's seat and an assistant sitting on a seat next to the driver to easily perform an operation of exchanging information of the first display 170 and the second display 180. Regarding options displayed in the first image display region 174 or the second image display region 184, additional information of the options described in the first embodiment may be displayed together.

While the embodiments for implementing the present invention have been described using embodiments, the present invention is not limited to these embodiments and various modifications and substitutions can be added without departing from the scope of the present invention.

What is claimed is:

1. A display device, comprising:
a plurality of displays;
a display controller configured to determine each content of information to be displayed by each of the plurality of displays and to display the determined each content of information on each of the plurality of displays; and
a receiver configured to receive a selection operation of an occupant,
wherein in a case where an operation of selecting one of a plurality of options in a first mode is received by the receiver in a state where list information including the plurality of options is displayed on a first display included in the plurality of displays, the display controller is configured to display relevant information related to the option selected in the first mode on a second display different from the first display among the plurality of displays.

2. The display device according to claim 1, wherein the display controller is configured to display the relevant information on the first display in a case where the option selected in the first mode is selected in a second mode.

3. The display device according to claim 2, wherein the display controller is configured to display on the second display information displayed before displaying the relevant information on the second display in a case where the option selected in the first mode is selected in the second mode.

4. The display device according to claim 2, wherein the display controller is configured to display the list information on the second display in a case where the option selected in the first mode is selected in the second mode.

5. The display device according to claim 2, wherein the display controller is configured to display the list information on the second display until a predetermined period of time elapses in a case where the option selected in the first mode is selected in the second mode, and to display information displayed on the second display before displaying the relevant information on the second display in a case where an operation for the plurality of options is not received by the receiver over the predetermined period of time in a state where the list information is displayed on the second display.

6. The display device according to claim 1, wherein the display controller is configured to exchange information displayed on the first display and information displayed on the second display with each other in a case where an exchange instruction operation is received by the receiver.

7. The display device according to claim 4, wherein
the first display and the second display are provided in a vehicle including a driver's seat and a seat next to the driver, and the first display is disposed on a side closer to the driver's seat than the second display,
the second display is disposed on a side closer to the seat next to the driver than the first display, and
the display controller is configured to continuously display the relevant information on the first display in a case where the option selected in the first mode, among the options included in the list information displayed on the second display, is selected in the second mode.

8. The display device according to claim 7, wherein, in a case where the option selected in the first mode, among the options included in the list information displayed on the second display, is selected in the second mode, the display controller is configured to continuously display the list information on the second display or to display information displayed on the second display, before displaying the list information on the second display.

9. The display device according to claim 1, wherein
the list information is related to a list of energy supply stations, and
the display controller is configured to generate list information to be displayed on at least one of the first display and the second display on the basis of at least one of a traveling history and a traveling schedule of a vehicle on which the display device is mounted.

10. The display device according to claim 9, wherein the display controller is configured to separately perform first display in a first display mode for information on energy supply stations in a vicinity of a traveling path included in the traveling history and second display in a second display mode for information on energy supply stations in a vicinity of a traveling path included in the traveling schedule.

11. The display device according to claim 9, wherein the display controller is configured to exclude information on an energy supply station which is in a vicinity of a traveling path included in a traveling history of the vehicle and of which a distance from the vehicle is equal to or greater than a predetermined distance from the list information.
